(19) United States
(12) Patent Application Publication
(10) Pub. No.: US 2007/0140140 A1
(43) Pub. Date: Jun. 21, 2007

(54) SYSTEM AND APPARATUS FOR DISTRIBUTING DATA OVER A NETWORK

(75) Inventors: Mark Patrick John FEELEY, Kanata, ON (CA); Yatish KUMAR, Ottawa, ON (CA); Jonathan Alan Brooke BOOCOCK, Woodlawn, ON (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: TURNTV INCORPORATED, Kanata (CA)

(21) Appl. No.: 11/562,656

(22) Filed: Nov. 22, 2006

Related U.S. Application Data
(60) Provisional application No. 60/738,593, filed on Nov. 22, 2005.

(51) Int. Cl. H04J 1/16

(52) U.S. Cl. 370/252

(57) ABSTRACT

A system and method for the distribution of digital media content makes use of a network control element to manage the fragmentation of the digital content and to distribute the fragments of the digital content to different endpoint elements in the network. The network control element responds to endpoint element requests for the digital media content by allowing the various endpoint elements to store the fragments of the digital media content and to transfer the fragments to the requesting endpoint element under the control of the network management element. This spreads the network traffic across the network and prevents the development of a single bottleneck in the distribution network.

### CROSS REFERENCE TO RELATED APPLICATIONS

This application claims the benefit of priority of U.S. Provisional Patent Application No. 60/738,593 filed Nov. 22, 2005, which is incorporated herein by reference in its entirety.

### FIELD OF THE INVENTION

The present invention relates generally to file distribution. More particularly, the present invention relates to the management of the distribution of media files for playback using a plurality of network elements to transmit file fragments.

### BACKGROUND OF THE INVENTION

File distribution in an electronic network is often met with bottlenecks related to the connection bandwidth between the source and recipient. This problem is often exacerbated by multipoint file distribution, which provides a number of new potential bottlenecks. Typically files are transmitted through the network in their entirety from a source to a recipient endpoint. However, network topologies with large numbers of users, in which the number of files delivered, and where the file size or bandwidth required is large, the server size and bandwidth required becomes impractical. This problem is typically experienced during the distribution of streaming content in a video-on-demand distribution network.

In some systems the files are also transmitted from endpoint to endpoint to relieve the source of the load of transmitting the file to as many endpoints as there would have otherwise been. This type of distribution is generally known as peer to peer. In more advanced peer to peer schemes, fragments of files may be transmitted from multiple supplier endpoints to a receiving endpoint, rather than transmitting a whole file from one endpoint to a receiving endpoint. These systems are generally known as swarming systems.

Topologies which distribute files or media from endpoint to endpoint, whether point to point or using swarming schemes, can reduce the server bandwidth requirements, but these topologies also can be ineffective in certain applications. In particular, when endpoints are connected to each other over a low bandwidth connection, or are connected to each other using asymmetric connections, streaming or download rates can be unsatisfactory.

The inability to transmit large data files limits the ability to provide often desired features such as high quality media on demand. It is, therefore, desirable to provide a network architecture, and enabling network elements, to provide an improved bandwidth usage during the transmission of media files, especially when files are distributed from endpoint to endpoint.

### SUMMARY OF THE INVENTION

It is an object of the present invention to obviate or mitigate at least one disadvantage of previous file distribution networks.

In embodiments of the present invention, there is provided a system and method for managing the delivery of digital files or media, composed of one or more network control elements, one or more content ingestion elements and any number of network connected endpoint elements with digital storage capacity, in which a digital file or media stream is first divided into fragments and then such fragments are distributed from the content ingestion elements under the control of the network control elements, to some or all of the endpoint storage elements, and wherein such fragments may be subsequently retrieved and reassembled by any of the endpoint elements under the control of the network control elements. The digital file or media fragment can be stored on one or multiple endpoint units. Some of the fragments for one of the digital files or media streams can be stored on content ingestion elements. The content ingestion nodes and endpoints preferably connect to each other over a virtual private network in which the endpoint elements require certification or authentication from the network control elements in order to provide digital fragments to other endpoint elements or in order to retrieve and reassemble the digital streams from the other endpoints or the central element. The network control element in the system can be used to maintain records of which endpoints have stored which fragments, and in one embodiment optimizes the distribution of the fragments. The network control element can be used to optimize, for either speed or transfer time, the transfer of fragments between elements in the fragment reassembly process. The optimization of the transfer of fragments can be performed to manage traffic levels at various points in the network. The network control elements can determine which endpoint units receive and have access to which digital file or stream in the network, this control can be exercised to provide subscription control and to optimize fragment distribution based on anticipated digital file or digital media stream usage levels within the network topology or to optimize endpoint element resource usage, including memory or processor capacity. The endpoint storage units can be implemented as software executed on either general purpose computer hardware or on units dedicated to receiving and transferring digital files.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a network diagram illustrating the use of the present invention to distribute digital media files;

FIG. 2A is a functional block diagram showing the main functional components of the system, according to an embodiment of the present invention;.

FIG. 2B is a functional block diagram showing the main functional components of the system when there are multiple endpoint elements, according to an embodiment of the present invention;

FIG. 3A is a flowchart showing the content ingestion and network seeding flow method, according to an embodiment of the present invention;

FIG. 3B is a flowchart showing the content topology management flow method, according to an embodiment of the present invention; and, FIG. 3C is a flowchart showing the content download flow method, according to an embodiment of the present invention.

### DETAILED DESCRIPTION

Generally, the present invention provides a system and method for the distribution of digital media content in a public network. A network control element is used to manage the fragmentation of the digital content and to distribute the fragments of the digital content to different endpoint elements in the network. The network control element responds to endpoint element requests for the digital media content by allowing the various endpoint elements to store the fragments of the digital media content and to transfer the fragments to the requesting endpoint element under the control of the network management element. This spreads the network traffic across the network and prevents the development of a single bottleneck in the distribution network.

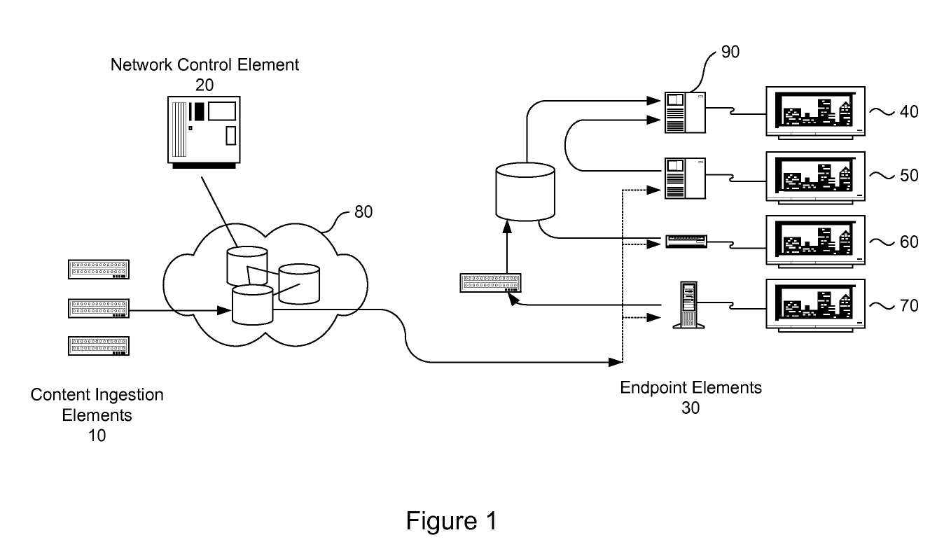

An illustration of a system of the present invention operating on a public network is provided in FIG. 1. The system of the present invention makes use of a central server connected to at least one content ingestion element 10, a network control element 20 and at least one endpoint element 30. The content ingestion element 10 may divide the media file or stream into smaller fragments which can be transmitted through the network 80. The endpoint elements 30 preferably include digital storage capacity and have the ability to reassemble a file or stream from discrete elements that are received out of order.

In this topology, the digital files or digital media streams (such as video) are divided into multiple smaller fragments by the content ingestion elements 10. The fragmentation of the original data file or stream can be performed using any number of different techniques including simple time slicing.

The content ingestion elements 10 distribute the fragments to the endpoint elements 30 under the control of the network control element 20. Distribution of the fragments to the endpoint elements 30 can make use of any of a number of known file distribution techniques. The network control elements 20 may distribute data to each of the endpoint elements 30 when the file or stream is requested, or they may begin file distribution prior to the receipt of a file distribution request.

When an endpoint element 30, referred to as a receiving endpoint element requests a file, or other such content, it is certified and authenticated by the network control element 20. The network control element 20 then instructs other endpoint elements 30 to begin transmitting the requested data to the requesting endpoint 90. The requesting endpoint 90 will receive data from the supplying endpoint elements 30, and will reassemble the data fragments to create the full file. In the case of a digital media stream, this can be played directly to a television, display device, or digital media player.

An example of the operation of the above described system is now provided for exemplary purposes. A content source prepares a video file for distribution to a series of subscribers. The subscribers may or may not watch the prepared program, but have all subscribed to have access to the content from that provider. Whereas in the prior art, the subscriber would contact the content source or sources and begin receiving the content, the system of the present invention avoids the large demands placed on the content provider when a number of users all begin requesting large amounts of data in real time. In place, the system of the present invention attempts to provide a managed swarming effect.

This is accomplished by providing the content to the end users through a network control element 20. The network control element 20 manages the distribution of the content to the users in fragments. The content is thus pushed to the network edge in an orderly fashion and the topology of the content in the network can be chosen so as to optimize usage of the network or endpoint facilities. The network control element 20 allows different end user systems to store different portions of the content, and allows coordination between the systems at the edge of the network so that the content portions can be transferred from endpoint element 30 to endpoint element 90 without interaction with the content source. Thus, the bandwidth consumption used in the distribution process is spread through the entire network instead of being concentrated at a small set of core nodes. This allows for greater network scalability and reduces the demands placed on network providers. By providing the network control elements 20 with the ability to monitor network connections, the network control elements 20 can develop a topological map of the network edge and can avoid network limitations. By replacing the high single point demand with a more distributed demand, more data may be transferred but the load is spread out resulting in a more infrastructure friendly system.

The network control element 20 is used to manage the distribution of the content and the connections between endpoint elements 30. The network control element 20 can be provided with subscriber information to allow only subscribers to a particular content provider to receive that content. This allows the users that have subscribed to a particular content provider to bear the distribution load amongst themselves and will not have to impose bandwidth consumption on units that do not subscribe to a particular type of content. Furthermore, the network control element can function as a gatekeeper by maintaining content specific authorizations, contributor validation and authorization information and an electronic programming guide based on user subscriptions. The network control element 20 can also make use of different content distribution algorithms and provide fragment tracking to the endpoint elements 30 to allow each endpoint element to find the closest endpoint element 30 having a particular content fragment.

By using a network control element 20 to pre-distribute fragments of content to different endpoint elements 30, and then assist the endpoint elements 30 in finding the fragments that they do not have, traffic management can be implemented using dynamically created network topological maps. This allows for swarm management to avoid a single node being battered by requests from every node in the network, behavior that will result in an effective distributed denial of service attack. By creating a dynamic network map, the awareness of the network allows the network control element 20 to aid in the determination of which fragments should be obtained where to result in the best possible user experience.

By requiring each endpoint element 30 to connect to the network control element to access the content in the network, security can be provided. Content fragments can be encrypted during distribution and storage and then unlocked during playback using a key provided by the network control element 20. Thus, even if an endpoint element 30 receives content for which there is no subscription, the content cannot be played. Billing matters for subscriptions, pay per view content and advertising display can be administered by the network control element 20. If programming is broken into fragments and indications are provided to show where in the program stream commercial advertising can be provided, the network control element 20 can assist in the selection of advertising from known lists. The frequency with which advertisements are played can provide an advertising audit trail for network administrator, the content provider and the advertiser.

By seeding endpoint elements 30 with fragments of created content, the network control element 20 reduces the amount of traffic that is generated to a specific node. Based on a known network topology, the fragments can be distributed to provide the users with a seamless viewing or listening experience while providing buffered viewing and not requiring that the full program be available on the user unit prior to the start of the programming display.

A more specific embodiment of the present invention will now be described, by way of a functional block diagram and flow charts illustrating the processes for Content Ingestion and Network Seeding, Content Topology Management and Content Download, with reference to the attached Figures.

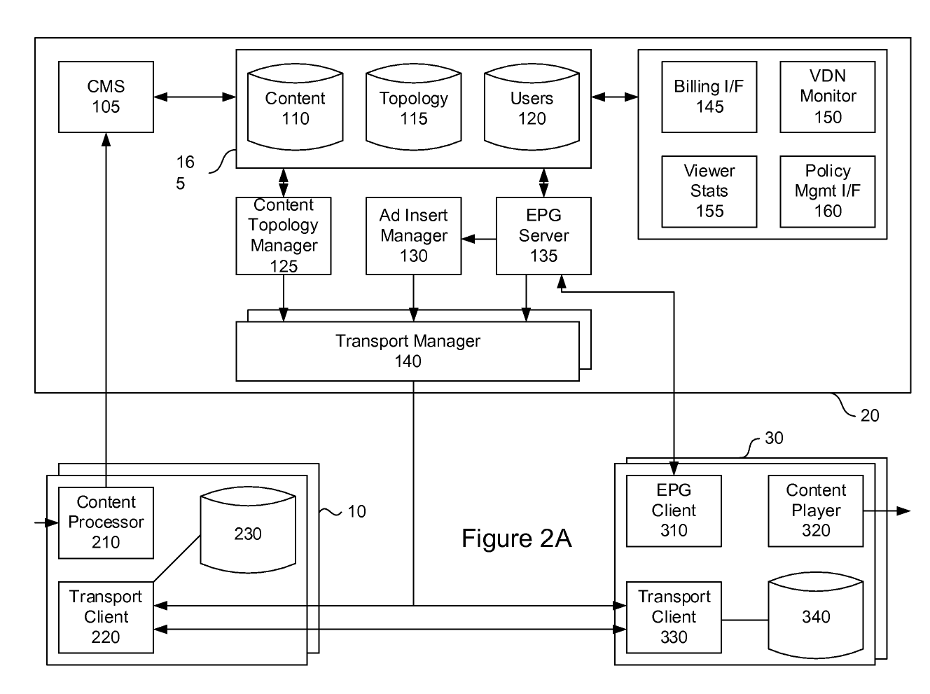

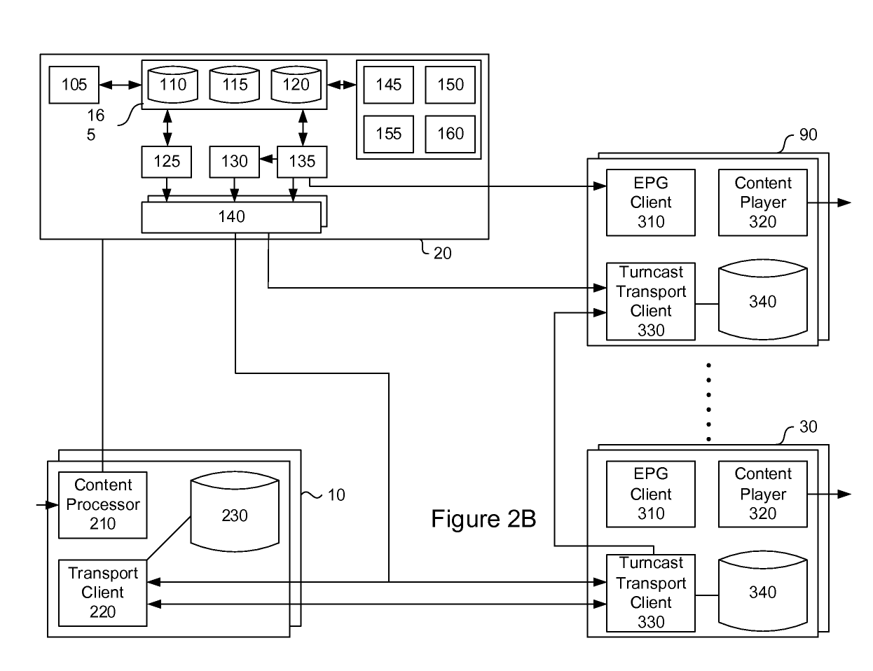

The main functional components of the system are described in FIGS. 2A and 2B. The basic elements of the system are the network control element 20 that provides all network management functions, the content ingestion elements 10 where all new content is ingested into the system, and endpoint elements 30 that are software clients running on different hardware platforms including (but not limited to) dedicated set-top boxes 40, multimedia PC's 50, personal computers 60, or a multitude of different gaming platforms including Xbox 360, PS3, etc. 70.

The network control element 20 consists of the following functional blocks: A content management system 105 that stores all metadata relevant to content that is ingested into the system; a content database 110 that stores information about where all content fragments are stored in the network; a topology database 115 that stores information about the network topology, the topology database captures static information such as link rates, equipment types as well as active information on link capacity available; a user database 120 which stores all information about end users of the system, and can include user information such as subscriber address, billing address, endpoint equipment and current status, endpoint storage size and credit card information; a network control element database 165, which is made up of the content database 110, the topology database 115, and the user database 120; a content topology manager 125 that utilizes a series of algorithms to determine what endpoints to place content fragments on based on the predicted likelihood that the content will be requested, knowledge of the network topology and endpoint element 30 status. It may be desirable to place sufficient numbers of copies of content in network regions close to the edge of the network, as this will reduce the amount of traffic that will cross through the core of the network to satisfy a request for a particular piece of content from an end user.

Further components of the network control element 20 are as follows. An ad insertion manager 130 is responsible for the management of inserting advertisements in the video stream viewed by an end user. An Electronic Program Guide (EPG) server 135 receives requests from the endpoint EPG clients 310, determines whether endpoint elements 30 can access requested content, and generates a list of suitable endpoint elements 30 to acquire the content from a transport manager 140. A transport manager 140 is responsible for receiving a list of endpoints that are to receive particular content fragments from the content topology manager 125, ad insertion manager 130 and EPG server 135, and provides acquisition instructions to the appropriate endpoint elements 30 on where to obtain the requested content fragments. The transport manager 140 provides authorization to the supplying endpoint elements 30 for approved transactions. A billing interface 145 provides an interface between the network control element 20 and third party customer billing systems. A VDN monitor 150 allows system operators to monitor system performance and diagnose and troubleshoot system performance issues. A viewer statistics module 155 allows the viewing and processing of important statistical information relating to viewers and content. A policy management interface 160 provides interfaces to network management systems and user policy management systems in order to integrate management of the video distribution network with the overall network management.

Each content ingestion element 10 consists of the following functional blocks. A content processor 210 receives all content that enters the system. For example, a video file is received by the system, the metadata is extracted and delivered to the CMS 105. Then the video is trans-coded and broken into fragments and the fragments are stored in the content ingestion storage 230. A transport client 220 receives a list of clients to distribute the content fragments to from the transport manager 140. The transport client 220 will establish a connection to the endpoint elements 30 and distribute the content fragments. A content ingestion element storage 230 is used to store content fragments.

Each endpoint element 30 consists of the following functional blocks. An electronic programming guide client 310 is where the end user uses a graphical interface controlled by either a wireless remote control or a computer input device (mouse or keyboard), to browse through and select available programming for download and viewing. The EPG data is delivered from the EPG Server 135. A content player 320 will play the selected content on the endpoint element once the content has been selected and the fragments are acquired over the network. The player will reassemble the fragments received and play the video content to the appropriate display device. A transport client 330 interacts with the transport manager 140 such that when a piece of content is selected for downloading, the transport manager 140 will provide a list of transport clients 330 that have the fragments for the selected content. The transport manager 140 will then make requests to the relevant transport clients 330 to send the requested fragments. Once received, the fragments will be stored on the endpoint storage 340 of the endpoint element 30. The transport manager 140 is responsible for ensuring that all fragments required to complete the content are available for playing by the content player 320. The endpoint storage 340 is where all content fragments are stored on the endpoint element 30. Storage is typically in the form of a hard disk drive but could optionally be memory or mass storage means of any kind.

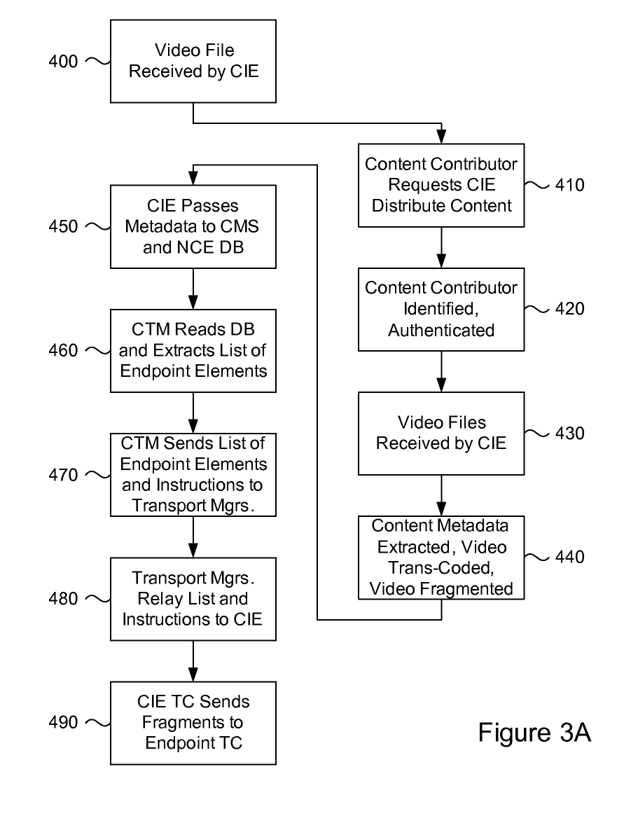

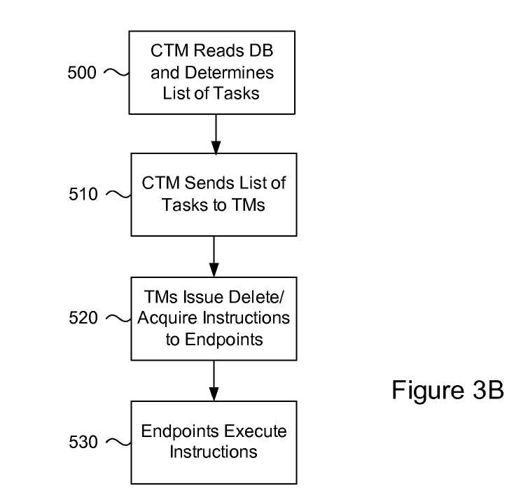

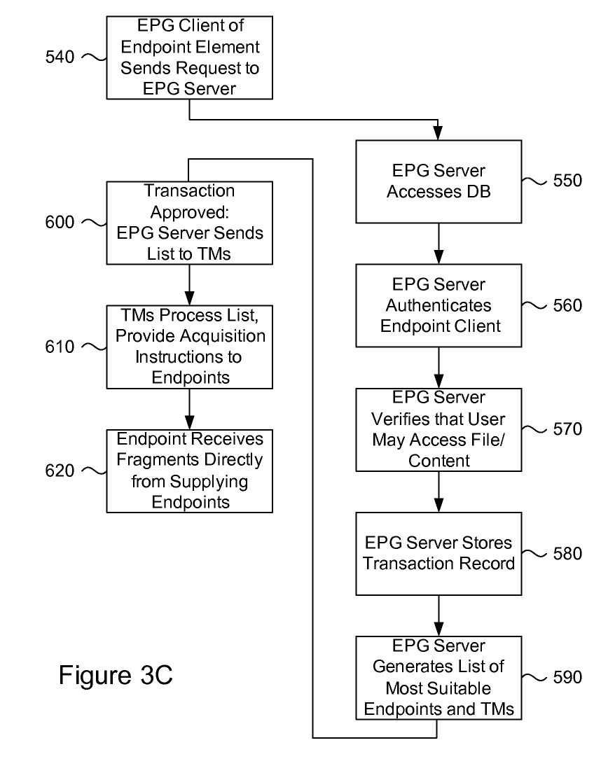

Flow charts illustrating the processes for content ingestion and network seeding, content topology management and content download follow with reference to FIGS. 3A, 3B and 3C. The content ingestion and network seeding flow method of the present invention is shown in FIG. 3A. At step 400, a video file is received by the content ingestion element (CIE) 10. At step 410, a content contributor sends a request to the CIE 10 to distribute content. At step 420, the content contributor is identified and authenticated. At step 430, the video files are received by the CIE 10. At step 440, the content description or metadata is extracted, and video is trans-coded and fragmented by the content processor 210. At step 450, the CIE 10 passes metadata to the content management system (CMS) 105 and enters data into the network control element (NCE) database 165, with “awaiting delivery” status.

At step 460, the content topology manager (CTM) 125 reads the NCE database 165 and extracts data for entries awaiting delivery along with data relating to endpoint status and network topologies, and through a sequence of algorithms which optimize the content topology, determines a list of appropriate endpoint elements 30 to receive the file or file fragments. At step 470, the CTM 125 sends a list of endpoint elements 30 and instructions for fragment distribution to one or more relevant transport managers 140. At step 480, the transport managers 140 relay the list and instructions to the CIE 10. At step 490, the transport client (TC) 220 within the CIE 10 communicates directly with TC's 330 within endpoint elements 30 to establish a connection, and then sends the fragments to the endpoint elements 30 as directed by the instructions received from the CTM 125.

The content topology management flow method of the present invention is shown in FIG. 3B. At step 500, the content topology manager (CTM) 125 reads the NCE database 165 and extracts data relating to content status, endpoint status and network topologies, and through a sequence of algorithms which optimize the content topology, determines a list of tasks, consisting of content deletion instructions and fragment acquisition instructions. At step 510, the CTM 125 sends the list of tasks to one or more relevant transport managers (TM) 140. At step 520, the TMs 140 receive the task lists and issues detailed “delete” instructions and “acquire” instructions (along with addresses of endpoints from which to acquire fragments) to the relevant endpoint elements 30. At step 530, the endpoint elements 30 execute any delete instructions directly and communicate directly with the set of endpoint transport clients 330 indicated in the instructions in order to receive fragments from those transport clients 330.

The content download flow method of the present invention is shown in FIG. 3C. At step 540, the EPG client 310 of an endpoint element 90 sends a transaction request to the EPG server 135 (via a web page presentation of an EPG). At step 550, the EPG server 135 accesses the NCE database 165. At step 560, the EPG server 135 authenticates the endpoint client 310. At step 570, the EPG server 135 verifies that the user may access that file or content. At step 580, the EPG server 135 enters a transaction record (which may be later used for billing or network statistics). At step 590, the EPG server 135, through a set of network traffic optimization algorithms, generates a list of most suitable endpoint elements 30 and TM 140 addresses for content acquisition. At step 600, the EPG server 135 sends the list of appropriate addresses to the relevant TMs 140 and indicates that the transaction is approved to proceed. At step 610, the TMs 140 process the list, provide acquisition instructions to the receiving endpoint element 90, and signal the transaction authorization to the supplying endpoint elements 30. At step 620, the receiving endpoint element 90 communicates directly with the supplying endpoint elements 30 and receives the fragments directly from those clients.

In contrast to traditional swarming or point to point peer to peer systems which establish connections between endpoints on a best effort, non-optimized basis with no consideration of network, content or user topology, the embodiments of the present invention provide a management system and architecture which solves network bandwidth utilization problems by considering these topologies. In particular the system utilizes a distributed content management approach which provides the capability to establish and control the content distribution with respect to the network topology so that bottlenecks can be avoided. Further, the establishment of peer to peer connections or swarms is performed by the network control element with awareness of the network, content or user topologies. In addition, the network control element provides functions of authentication and certification in order to enhance the security of the content and network similar to the operation of a virtual private network.

In summary, according to the embodiments of the present invention, there is provided a system and method for managing the delivery of digital files or media, composed of one or more network control elements, one or more content ingestion elements and any number of network connected endpoint elements with digital storage capacity, in which a digital file or media stream is first divided into fragments and then such fragments are distributed from the content ingestion elements, to some or all of endpoint storage elements under the control of the network control elements, and wherein such fragments may be subsequently retrieved and reassembled by any of the endpoint elements under the control of the network control elements.

The digital file or media fragment can be stored on one or multiple endpoint units. Some of the fragments for one of the digital files or media streams can be stored on content ingestion elements. The content ingestion nodes and endpoints preferably connect to each other over a virtual private network in which the endpoint elements require certification or authentication from the network control elements in order to provide digital fragments to other endpoint elements or in order to retrieve and reassemble the digital streams from the other endpoints. The network control element in the system can be used to maintain records of which endpoints have stored which fragments, and in one embodiment optimizes the distribution of the fragments.

The network control element can be used to optimize, for either speed or transfer time, the transfer of fragments between elements in the fragment reassembly process. The optimization of the transfer of fragments can be performed to manage traffic levels at various points in the network. The network control elements can determine which endpoint units receive and have access to which digital file or stream in the network. This control can be exercised to provide subscription control and to optimize fragment distribution based on anticipated digital file or digital media stream usage levels within the network topology or to optimize endpoint element resource usage, including memory or processor capacity. The endpoint storage units can be implemented as software executed on either general-purpose computer hardware or on units dedicated to receiving and transferring digital files.

The above-described embodiments of the present invention are intended to be examples only. Alterations, modifications and variations may be effected to the particular embodiments by those of skilled in the art without departing from the scope of the invention, which is defined solely by the claims appended hereto.

What is claimed is:

1. A file distribution system for a plurality of endpoint elements in a network, comprising:
a content ingestion element for receiving a digital file, the content ingestion element transcoding the digital file and dividing the transcoded digital file into fragments, the fragments being stored in mass storage means of the content ingestion element;
a network control element for controlling the content ingestion element to distribute each of the fragments to a set of endpoint elements, the set of endpoint elements being selected from the plurality of endpoint elements based on a network topology, the network control element providing addresses corresponding to supplying endpoint elements selected from the set of endpoint elements in response to a transaction request; and,
a receiving endpoint element for transmitting the transaction request and for receiving the addresses of the supplying endpoint elements, the receiving endpoint element retrieving each of the fragments directly from each of the supplying endpoint elements.

2. The file distribution system of claim 1, wherein the content ingestion element includes
a content processor for transcoding the digital file and for dividing the transcoded digital file into fragments, and
a content transport client for transmitting each of the fragments to the set of endpoint elements.

3. The file distribution system of claim 1, wherein the network control element includes
a topology manager for selecting the set of endpoint elements from the plurality of endpoint elements in response to a performance optimization algorithm using parameters of the network topology and anticipated usage of the content,
an electronic programming guide server for receiving and authenticating the transaction request, the electronic programming guide server selecting the supplying endpoint elements from the set of endpoint elements, and,
a transport manager for providing the addresses corresponding to the supplying endpoint elements to the receiving endpoint element.

4. The file distribution system of claim 3, wherein the network control element includes
a topology database for storing the parameters of the network topology, the parameters including link rates, equipment types, link capacity and bandwidth of the network, and
a content database for storing the addresses of each fragment of content in the plurality of endpoint elements.

5. The file distribution system of claim 3, wherein the network control element includes an ad insertion manager for providing an advertisement to the transport manager for transmission to the receiving endpoint element.

6. The file distribution system of claim 1, wherein the receiving endpoint element includes
an electronic programming guide client for transmitting the transaction request for the digital file,
an endpoint transport client for receiving one of the fragments from the content ingestion element and for receiving the addresses corresponding to the supplying endpoint elements, the endpoint transport client retrieving each of the fragments directly from each of the supplying endpoint elements,
a content player for reassembling the fragments retrieved from the supplying endpoint elements into the digital file.

7. The file distribution system of claim 1, wherein the receiving endpoint element is one of the set of endpoint elements.

8. The file distribution system of claim 1, wherein each fragment is distributed to more than one endpoint element of the set of endpoint elements.

9. The file distribution system of claim 1, wherein at least one of the fragments is retrievable exclusively from the mass storage means.

10. The file distribution system of claim 3, wherein the electronic programming guide server executes a network traffic optimization algorithm for selecting the supplying endpoint elements by maximizing download speed by the receiving endpoint element.

11. The file distribution system of claim 3, wherein the electronic programming guide server executes a network traffic optimization algorithm for selecting the supplying endpoint elements by maintaining traffic of network nodes at predetermined levels.

12. A method for downloading a digital file from a network, comprising:
a) dividing the digital file into fragments;
b) selecting a set of endpoint elements from a plurality of endpoint elements in the network for receiving each of the fragments;
c) distributing each of the fragments to each of the endpoint elements of the set of endpoint elements;
d) transmitting a request for the digital file from a receiving endpoint element;
e) providing addresses corresponding to supplying endpoint elements to the receiving endpoint element in response to the request, the supplying endpoint elements being selected from the set of endpoint elements;
f) retrieving by the receiving endpoint element, the fragments stored in the supplying endpoint elements; and,
g) assembling the fragments into the digital file.

13. The method of claim 12, wherein the step of selecting a set of endpoint elements includes determining the set of endpoint elements which satisfy a performance criteria.

14. The method of claim 13, wherein the performance criteria includes determining the set of endpoint elements based on anticipated usage of the digital file in the network and the network topology.

15. The method of claim 12, wherein the step of providing addresses includes determining the supplying endpoint elements based on the receiving endpoint element resource usage, the resource usage including at least one of memory capacity, processor capacity and bandwidth, for maximizing download speed by the receiving endpoint element.

16. The method of claim 12, wherein the step of providing addresses includes determining the supplying endpoint elements based on maintaining traffic levels at nodes of the network at predetermined levels.

17. The method of claim 12, wherein the step of retrieving includes authorizing the receiving endpoint element to retrieve the fragments from the supplying endpoint elements, and authorizing the supplying endpoint elements to provide the fragments to the receiving endpoint element.

18. The method of claim 12, wherein the step of transmitting the request for the digital file includes authenticating the receiving endpoint element.

19. The method of claim 18, wherein the step of authenticating includes verifying access to the digital file by the receiving endpoint element.

20. The method of claim 12, wherein the step of dividing includes extracting metadata from the digital file.
